(19) United States
(12) Patent Application Publication
(10) Pub. No.: US 2015/0161907 A1
(43) Pub. Date: Jun. 11, 2015

(54) DALLY TRAINING APPARATUS

(71) Applicant: Blake Pacheco, Salinas, CA (US)

(72) Inventor: Blake Pacheco, Salinas, CA (US)

(21) Appl. No.: 14/565,310

(22) Filed: Dec. 9, 2014

Related U.S. Application Data
(60) Provisional application No. 61/913,804, filed on Dec. 9, 2013.

(51) Int. Cl. G09B 19/00

(52) U.S. Cl. CPC G09B 19/00

(57) ABSTRACT

A dally training rope apparatus for practicing the wrapping of a first end of a rope around a saddle horn. The invention further relates to a second end of said rope being attached to at least one elongated elastic band for applying at least one tension force to said rope for retracting said rope so that a person using the apparatus can practice the formation of a dally with said rope.

### PRIORITY

This application claims priority to Provisional Patent Application No. 61/913,804, Dally Training Apparatus, filed on Dec. 9, 2013.

### FIELD OF THE INVENTION

The present invention relates in general to a training apparatus for improving livestock roping skills. More specifically, the invention relates to an exercise dally training rope apparatus.

### BACKGROUND OF THE INVENTION

This invention relates to an apparatus for assisting a user in practicing dallying. Dallying is the act of wrapping a rope around the horn of a saddle. Dallying is one of the fundamental skills involved in roping livestock which many cowboys and cowgirls need to practice for roping competition in tournaments, rodeos, etc. It is important for such cowboys and cowgirls to achieve a high level of skill at dallying. Speed and proper technique can give a competitive advantage and improper dallying can result in serious injuries. For example, team roping is a timed contest in a rodeo that features two cowpersons competing together: a “header” and a “heeler”. The header ropes the steer's head, dailies (wraps the end of the rope around the saddle horn) and pulls the steer with the rope. The heeler then ropes the back legs of the steer, dallies, and stops his horse. When the heeler catches and dallies and both ropes are tight, the header stops and turns his horse to face the heeler, and the clock is stopped. The team with the fastest time wins the competition.

In rodeo competition, the steer roping event is best described as fast paced action and there is no room for error. It is a race against the clock and only hundredths of a second may distinguish the winners from the losers. Thus, it is vitally important that each phase of the event be performed as rapidly and instinctively as possible. Many hours of practice are spent in the practice of roping and the formation of the dally. It is also extremely important to practice the formation of the dally to prevent the roping horseback rider's finger, thumb, or hand from being caught between the saddle horn and the rope during the formation of the dally. In the event this occurs, the extreme tension in the rope can sever a finger or severely damage a hand or wrist. Somewhat surprisingly, experience has shown that the risk of injury is greater if the horseback rider looks at the rope and saddle horn while forming the dally than if the rider is looking at the roped livestock. Hence, it is extremely crucial that the rider be able to instinctively form the dally, without looking down at the saddle horn, while maintaining eye contact and attention on the action at the other end of the rope.

One of the major problems encountered by those who desire to become skillful at dallying is obtaining sufficient practice time. U.S. Pat. No. 4,353,546 relates to a dally practice apparatus for practicing the art of dallying. This invention provides a first end of a rope that is to be wrapped around a saddle horn, and second end of the rope coupled to a load which applies tension to the rope to simulate the tension created by a roped steer. This dally practice apparatus is bulky, not mobile, and does not accurately simulate the tension produced by a steer since the rope is connected to a roller that is stationary. In essence, a user of the apparatus does not get to experience the full range of motion, along with the tension generated on the rope once an actual steer's head or back legs have been roped.

Other dally training systems have been developed, such as the dally practicing system described by Hughes in U.S. Pat. No. 7,101,186. The '186 patent describes a portable dally practicing system which simulates the conditions of roping a steer that utilizes a clutch system and a safety release mechanism. This dally practice system and the related hardware can be rather expensive, bulky, and not mobile which could impede a user's ability to practice.

Another dally training apparatus that has been developed is described by Harrell in U.S. Pat. No. 5,826,412. The apparatus in the '412 patent is designed and configured to simulate the front end of a conventional saddle which is compact in size and is adapted to be removably secured to a user. This dally practice apparatus allows a user to practice the art of dallying but the user does not get to experience the tension generated on a rope once a steer's head or back legs have been roped since this apparatus only simulates the front end of a saddle.

In light of the short comings in the prior art, a dally training apparatus is highly desired that overcomes the problems noted above. Furthermore, a dally training apparatus is highly desired that is inexpensive and mobile which will allow a user to conveniently practice many hours in order to develop a high level of dallying skills.

### BRIEF SUMMARY OF THE INVENTION

The present invention provides for a new dally training apparatus, Which comprises a rope having a first end and an opposing second end, wherein the first end of the rope being accessible in front of the dallier. The present invention also provides for at least one elongated elastic band having a first end and an opposing second end; and a first fastener for attaching the second end of the rope to the first end of at least one elongated elastic band. The present invention further provides for the second end of at least one of the elongated elastic bands being attached to a second fastener, wherein the second fastener can be attached to a substantially fixed object.

The preferred embodiment of the invention includes a tension means generated by at least one of the elongated elastic bands for applying at least one tension force to said rope for retracting said rope so that a person using a saddle like apparatus can practice the formation of a dally with said rope.

The present invention also provides for a new dally training apparatus that consists of material having a one piece assembly that is strong, durable and reliable,

The present invention as well provides for a new dally training apparatus that can be easily and efficiently manufactured and marketed and can also be easily used by a child to develop the skills of dallying.

The present invention additionally provides for a new dally training apparatus that allows an individual to practice for hours to develop muscle memory to become highly skilled at the art of dallying without the fear of injuring a hand and/or finger(s).

The present invention further provides a new dally training apparatus that is mobile and can easily fit into a rope bag.

An even further feature of the present invention is to provide a new, low-cost dally training apparatus that is fast and easy to assemble and use.

An yet an even further feature of the present invention is that it provides for a new dally training apparatus that allows a user to conveniently warm up before a team roping event.

The present invention even further provides for a new dally training apparatus that can generate various amounts of tension to the dally rope when using various elongated elastic bands for retracting said dally rope depending on a user's skill level When practicing dallying.

Accordingly, for a better understanding of the invention, its operating advantages and the various uses attained by the invention, reference should be made to the accompanying drawings and descriptive matter in which there are illustrated preferred embodiments of the invention.

### BRIEF DESCRIPTION OF THE DRAWINGS

FIG. 1 is a top view of the dally training apparatus.

FIG. 2 is a side view of the dally training apparatus. The cowboy sitting on the saddle like apparatus that includes a saddle horn is for illustrative purposes only and does not forms no part of the claimed invention.

### DETAILED DESCRIPTION OF THE INVENTION

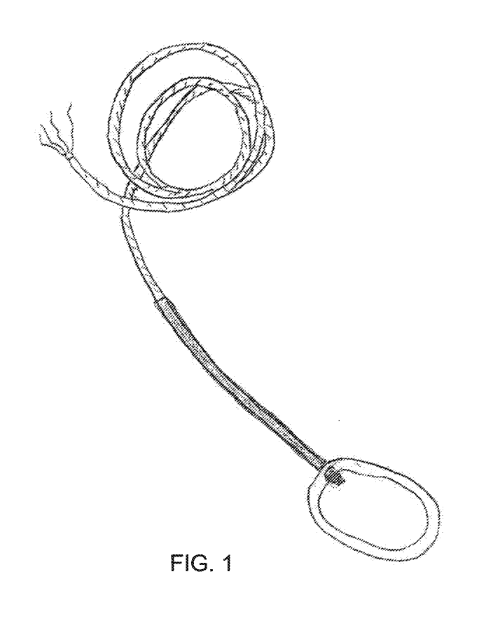

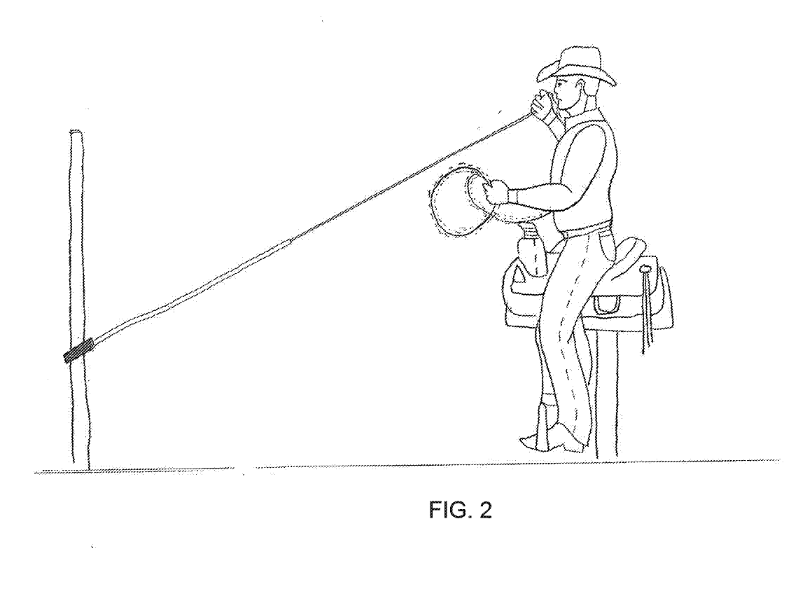

With reference to the drawings, there is illustrated the preferred embodiments of the invention 100 as shown in FIGS. 1-2, a new dally training apparatus, which comprises a rope 10 of preselected length having a first end 5 and an opposing second end 20, wherein the first end of the rope 10 being accessible in front of a dallier as depicted in FIG. 2.

The present invention also provides for at least one elongated elastic band 50 having a first end 40 and an opposing second end 60, and a first fastener 30 for attaching the second end of the rope 20 to the first end of at least one elongated elastic band 40. The present invention further provides for the second end of at least one of the elongated elastic bands 60 being attached to a second fastener 70, wherein the second fastener 70 can be attached to a substantially fixed object.

The preferred embodiment of the invention further includes a tension means generated by at least one of the elongated elastic bands 50 for applying at least one tension force to said rope 10 for retracting said rope 10 so that a person using a saddle like apparatus can practice the formation of a dally with said rope 10.

The preferred embodiment of the new dally training apparatus is ideal for assisting a user or even a child in practicing dallying in order to develop the fundamental skills in roping for competitions or the like such as team roping, steer stopping, cattle branding, rodeos or simply for ranchers who want to develop the skill of dallying for their ranching chores. In essence, the new training apparatus allows a user or a child to develop the skills for instinctively forming a dally, without looking down at the saddle horn, while maintaining eye contact and attention on the action at the other end of the rope. Moreover, the time spent practicing the formation of a dally by a user or a child can also help to prevent injury since the user or the child will develop the necessary skills to become a skillful dallier.

The preferred embodiment of the invention 100 consists of rope 10 that can be made of various materials such as nylon, synthetic fiber, fiber-poly blended rope, polyester, rawhide or a polyester and nylon blend. Also, the rope 10 used by a header for the preferred embodiment of the invention is made to be more flexible than a rope 10 used by a healer, wherein the stiffness of the rope used by the header is selected from the group extra extra soft, extra soft, soft, medium, medium-hard, and hard. On the other hand, the rope 10 used by a healer is made to be stiffer than a rope 10 used by a header, wherein the stiffness of the rope 10 used by the healer is selected from the group extra extra soft, extra soft, soft, medium, medium-hard, and hard.

The optimal length of a rope 10 used by a header is generally between about 30 feet and about 32 feet, while the optimal length of a rope 10 used by a healer is between about 34 feet and about 36 feet. Also, the diameter of the rope 10 for the preferred embodiment of the invention 100 is between about 5/16 inches and about ⅜ inches. Furthermore, a wax can be applied to the rope 10 after it has been braided and stretched.

The various embodiments are disclosed in sufficient detail to enable those skilled in the art to practice and use the invention and are exemplary of the fact that other arrangements may be employed in practicing the invention which has been set forth herein for purposes of exemplification. It is understood that the invention is not limited to the embodiments or illustrated drawings set forth herein for descriptive purposes, but is to be limited only by the scope of the attached claim or claims, including a full range of equivalency to which each element thereof is entitled. It is also to be understood that the phraseology and terminology employed herein are for the purpose of description and should not be regarded as limiting.

What is claimed is:

1. A dally training apparatus comprising:
a rope having a first end and an opposing second end, wherein the first end of the rope being accessible in front of the dallyer;
at least one elongated elastic band having a first end and an opposing second end;
a first fastener for attaching the second end of the rope to the first end of at least one elongated elastic band; and
the second end of at least one of the elongated elastic bands attached to a second fastener, said elongated elastic bands for applying tensional force to said rope when said rope is retracted for simulating the formation of a dally with said rope.

2. A dally training apparatus according to claim 1, wherein the rope is made of nylon, synthetic fiber, fiber-poly blended rope, polyester, rawhide or a polyester and nylon blend.

3. A dally training apparatus according to claim 1, wherein the optimal length of a header's rope is between about 30 feet and about 32 feet.

4. A dally training apparatus according to claim 1, wherein a header's rope is made to be more flexible than a heeler's rope.

5. A dally training apparatus according to claim 4, wherein the stiffness of the rope is selected from the group extra extra soft, extra soft, soft, medium, medium-hard, and hard.

6. A dally training apparatus according to claim 1, wherein the optimal length of the healer's rope is between about 34 feet and about 36 feet.

7. A dally training apparatus according to claim 1, wherein a healer's rope is made to be more stiff than a header's rope.

8. A dally training apparatus according to claim 7, wherein the stiffness of the rope is selected from the group extra extra soft, extra soft, soft, medium, medium-hard, and hard.

9. A dally training apparatus according to claim 1, wherein the diameter of the rope is between about 5/16 inches and about ⅜ inches.

10. A dally training apparatus according to claim 1, wherein a wax is applied to the rope after the rope has been braided and stretched.

11. A dally training apparatus according to claim 1, wherein the apparatus allows a user or a child to develop a high level of skills for instinctively forming a dally.

12. A method for practicing the formation of a dally, said method comprising the steps of:
providing a rope having a first end and an opposing second end, wherein the first end of the rope being accessible in front of the dallyer;
providing at least one elongated elastic band having a first end and an opposing second end;
providing a first fastener for attaching the second end of the rope to the first end of at least one elongated elastic band;
attaching the second end of at least one of the elongated elastic bands to a second fastener;
attaching the second fastener to a substantially fixed object; and
generating a tension force to said rope with said elongated bands when said rope is retraced for simulating the formation of a dally with said rope.
